(19) United States
(12) Patent Application Publication
(10) Pub. No.: US 2015/0221023 A1
(43) Pub. Date: Aug. 6, 2015

(54) INFORMATION PROVIDING DEVICE, INFORMATION PROVIDING METHOD, INFORMATION PROVIDING PROGRAM, AND COMPUTER-READABLE STORAGE MEDIUM STORING THE PROGRAM

(71) Applicant: Rakuten, Inc., Shinagawa-ku, Tokyo (JP)

(72) Inventors: Kenjiro Numazu, Shinagawa-ku (JP); Ruka Sakurai, Shinagawa-ku (JP); Yusuke Murata, Shinagawa-ku (JP)

(73) Assignee: Rakuten, Inc., Shinagawa-ku, Tokyo (JP)

(21) Appl. No.: 13/978,685

(22) PCT Filed: Dec. 7, 2012
(86) PCT No.: PCT/JP12/81840

§ 371 Date: Jul. 8, 2013

(30) Foreign Application Priority Data
Mar. 30, 2012 (JP) 2012-079075

(51) Int. Cl. G06Q 30/08; G06F 17/30

(52) U.S. Cl. CPC G06Q 30/08; G06F 17/30864; G06F 17/30598; G06F 17/3089

(57) ABSTRACT

An information providing device according to an aspect comprises: a reception unit which receives a page request for access to a web page of an auction site from a user terminal, the page request containing an identifier for specifying a user; a search unit which extracts a purchase history corresponding to the identifier from a purchase history memory storing purchase histories of products and which specifies a product having been purchased by the user and corresponding to a content of the web page; and a transmission unit which transmits product information and the web page to the user terminal in order to display the product information of the product specified by the search unit, along with the web page on the user terminal in a state in which the user can display the product for auction at the auction site.

### TECHNICAL FIELD

The present invention relates to a device, method, program, and storage medium for providing users with information associated with an auction site on the Internet.

### BACKGROUND ART

Internet auctions are actively used because they allow even ordinary people to readily list products up for sale and take part in the bidding. In relation to this, Patent Literature 1 below describes the technology for recommending a user to transfer a product owned by the user, to a third person at an auction or the like. The recommending device described in the Literature uses a product purchase history to check whether the user purchased a product of the same kind earlier at time of purchase of a certain product, and if purchased, it determines that the purchase of the product is for replacement. Then the recommending device recommends the user to transfer the product having been purchased earlier, to a third person, in accordance with the determination result.

### CITATION LIST

### Patent Literature

Patent Literature 1: JP 2009-122780 A

### SUMMARY OF INVENTION

### Technical Problem

Since the recommending device described in the above Patent Literature 1 needs to recommend the user to transfer the product by e-mail, it requires some time and effort for the user to access the auction site from the e-mail and it cannot be always said that the foregoing technology is highly convenient.

### Solution to Problem

An information providing device according to an aspect of the present invention comprises: a reception unit which receives a page request for access to a web page of an auction site from a user terminal, the page request containing an identifier for specifying a user; a search unit which extracts a purchase history corresponding to the identifier from a purchase history memory storing purchase histories of products and which specifies a product having been purchased by the user and corresponding to a content of the web page; and a transmission unit which transmits product information and the web page to the user terminal in order to display the product information of the product specified by the search unit, along with the web page on the user terminal in a state in which the user can display the product for auction at the auction site.

An information providing method according to an aspect of the present invention is an information providing method to be executed by an information providing device, the information providing method comprising: a reception step of receiving a page request for access to a web page of an auction site from a user terminal, the page request containing an identifier for specifying a user; a search step of extracting a purchase history corresponding to the identifier from a purchase history memory storing purchase histories of products, and specifying a product having been purchased by the user and corresponding to a content of the web page; and a transmission step of transmitting product information and the web page to the user terminal in order to display the product information of the product specified by the search step, along with the web page on the user terminal in a state in which the user can display the product for auction at the auction site.

An information providing program according to an aspect of the present invention lets a computer execute: a reception unit which receives a page request for access to a web page of an auction site from a user terminal, the page request containing an identifier for specifying a user; a search unit which extracts a purchase history corresponding to the identifier from a purchase history memory storing purchase histories of products and which specifies a product having been purchased by the user and corresponding to a content of the web page; and a transmission unit which transmits product information and the web page to the user terminal in order to display the product information of the product specified by the search unit, along with the web page on the user terminal in a state in which the user can display the product for auction at the auction site.

A computer-readable storage medium according to an aspect of the present invention stores an information providing program for letting a computer execute: a reception unit which receives a page request for access to a web page of an auction site from a user terminal, the page request containing an identifier for specifying a user; a search unit which extracts a purchase history corresponding to the identifier from a purchase history memory storing purchase histories of products and which specifies a product having been purchased by the user and corresponding to a content of the web page; and a transmission unit which transmits product information and the web page to the user terminal in order to display the product information of the product specified by the search unit, along with the web page on the user terminal in a state in which the user can display the product for auction at the auction site.

According to these aspects, when the user attempts to access the web page of the auction site, the product having been purchased by the user and corresponding to the content of the website is specified. Then the specified product information is sent along with the web page to the user terminal and the product information, together with the web page, is displayed on the terminal.

The user's access to the auction site means that the user is interested in the auction. Therefore, when the information of the product to be a candidate for display for auction is displayed upon the access, the user is reminded of the possession as the auction display candidate at the time when the user is interested in the auction, whereby the user can be guided directly to an auction display operation. Since the product information of the auction display candidate corresponds to the web page of the auction site and is displayed along with the web page on the terminal, the user can readily determine whether the product is to be displayed for auction. As a consequence of these, the convenience associated with display for auction can be further improved.

In the information providing device according to another aspect, the transmission unit may transmit an auction display interface for display for auction at the auction site of the product specified by the search unit, the product information, and the web page to the user terminal, and the auction display interface and the product information may be displayed on the user terminal. This interface can simplify the user's auction display work.

In the information providing device according to still another aspect, when the user selects the auction display interface, the product information of the product specified by the search unit may be set in an input cell in an auction display page of the auction site. By automating the input in the auction display page in this manner, it becomes feasible to allow the user to reduce the input work by that degree and to readily perform the auction display work.

In the information providing device according to still another aspect, the transmission unit may transmit to the user terminal, a list addition interface for adding the product specified by the search unit, to a waiting list for later displaying the product for auction, the product information, and the web page, and the list addition interface and the product information may be displayed on the user terminal. By displaying the interface for later displaying the product for auction, the user is allowed to display the product for auction at any later point of time, without a need for implementing auction display at the time of display of the product information.

In the information providing device according to still another aspect, the search unit may extract the purchase history of a product for which a predetermined duration has elapsed since purchased by the user. By displaying the product owned over the predetermined duration by the user, as the auction display candidate, it is feasible to avoid presentation of a product for which the time since purchase is not so long yet and which has a relatively low possibility of display for auction. It is also feasible to prevent a product immediately after purchase from being erroneously displayed for auction.

In the information providing device according to still another aspect, the search unit may refer to a successful bid history memory storing successful bid histories at the auction site to extract the purchase history of a product for which the predetermined duration does not have elapsed since purchased by the user and whose successful bid price indicated by the successful bid history is higher than a purchase price indicated by the purchase history. When a successful bid is made for the product at the price higher than the purchase price, the information of the product is presented irrespective of its purchase time to the user, which can encourage the user to display the product for auction.

In the information providing device according to still another aspect, the predetermined duration may be set for each product genre. Use periods of products differ depending upon types thereof; therefore, when the predetermined duration is set for each product genre, the product information can be presented at appropriate timing.

In the information providing device according to still another aspect, the search unit may refer to a successful bid history memory storing successful bid histories at the auction site to extract the purchase history of a product whose successful bid price indicated by the successful bid history is higher than a purchase price indicated by the purchase history. When the information of the product resulting in a successful bid at the price higher than the purchase price is presented to the user, the user can be encouraged to display the product for auction.

In the information providing device according to still another aspect, the search unit may extract the purchase history of a product corresponding to the present time, based on a product attribute or based on a purchase time of a product indicated by an arbitrary purchase history in the purchase history memory. When the product information is presented in time with seasons of products (seasons with high demand), a product with a high possibility of making a successful bid can be presented as an auction display candidate to the user.

In the information providing device according to still another aspect, the search unit may refer to an auction display history memory storing auction display histories at the auction site and a successful bid memory storing successful bid histories at the auction site to extract the purchase history of a product which was purchased by the user, which is not displayed for auction at present, and which was not sold in the past. This configuration can present only the information of the product not displayed for auction at present, to the user.

In the information providing device according to still another aspect, the search unit may refer to a successful bid history memory storing successful bid histories at the auction site to extract the purchase history of a product whose successful bid price at the auction site is not less than a predetermined threshold, out of products indicated by the purchase history of the user. When a product sold for a price not less than a certain level is presented to the user, the user can be encouraged to display the product for auction.

In the information providing device according to still another aspect, the search unit may refer to a search history memory storing search histories at the auction site and an auction display history memory storing auction display histories at the site to determine a demand index based on a search count and an auction display count for each of products indicated by the purchase history of the user and extract the purchase history of a product the demand index of which is not less than a predetermined threshold. The search count can be regarded as a degree of user's interest in the product and the auction display count as a supply amount of the product. Therefore, when a product with expected demand not less than a certain level is presented to the user based on the search count and the auction display count, the user can be informed of the product that can be led to a successful bid.

In the information providing device according to still another aspect, the web page may a page showing a result of a search based on a query contained in the page request, and the search unit may specify a product matching the query. When the product matching the query used on the web page is presented to the user, the product under user's current interest can be presented as an auction display candidate. As a result, we can expect improvement in convenience associated with display for auction.

In the information providing device according to still another aspect, the query may contain at least one of a keyword and a predetermined product genre. This configuration allows the device to present a product corresponding to the keyword or the product genre to the user.

In the information providing device according to still another aspect, the query may contain both of the keyword and the product genre. This configuration allows the device to present a product corresponding to both of the keyword and the product genre to the user.

In the information providing device according to still another aspect, the purchase history memory may store at least one of purchase histories indicative of purchases at an online shopping site, purchase histories indicative of purchases at the auction site, and purchase histories indicative of purchases settled by payment through a payment system.

In the information providing device according to still another aspect, the purchase history memory may store the purchase histories indicative of the purchases at the online shopping site and the purchase histories indicative of the purchases at the auction site, and the product information of the product specified by the search unit may contain information indicative of at which site the product was purchased between the online shopping site and the action site. This reminds the user of a purchase route of the product or a quality of the product at purchase time (whether it was new or used) and allows the user to determine the necessity for display for auction, based on it.

In the information providing device according to still another aspect, the search unit may refer to at least one of a search history memory storing search histories at the auction site, an auction display history memory storing auction display histories at the site, and a successful bid history memory storing successful bid histories at the site to set a display order of the product information on the user terminal, and the display order may be set based on at least one of a demand index based on a search count and an auction display count, a successful bid price, the search count, and a purchase time. When the display order of products is set in this manner, the user can readily determine the necessity for display for auction.

### Advantageous Effect of Invention

According to one aspect of the present invention, the convenience associated with display for auction can be further improved.

### BRIEF DESCRIPTION OF DRAWINGS

FIG. 1 is a drawing showing an overall configuration of an auction system including an auction server according to an embodiment.

FIG. 2 is a drawing showing an example of purchase histories.

FIG. 3 is a drawing showing an example of auction display histories.

FIG. 4 is a drawing showing an example of successful bid histories.

FIG. 5 is a drawing showing an example of search histories.

FIG. 6 is a drawing showing a hardware configuration of the auction server shown in FIG. 1.

FIG. 7 is a block diagram showing a functional configuration of the auction server shown in FIG. 1.

FIG. 8 is a drawing showing an example of displaying auction display candidates along with a web page.

FIG. 9 is a drawing showing another example of displaying auction display candidates along with a web page.

FIG. 10 is a drawing showing still another example of displaying an auction display candidate along with a web page.

FIG. 11 is a drawing showing still another example of displaying auction display candidates along with a web page.

FIG. 12 is a sequence diagram showing an example of operation of the auction server shown in FIG. 1.

FIG. 13 is a sequence diagram showing another example of operation of the auction server shown in FIG. 1.

FIG. 14 is a sequence diagram showing still another example of operation of the auction server shown in FIG. 1.

FIG. 15 is a drawing showing a configuration of an information providing program according to an embodiment.

### DESCRIPTION OF EMBODIMENTS

Embodiments of the present invention will be described below in detail with reference to the accompanying drawings. In the below-described embodiments, the information providing device according to the present invention will be applied to an auction server. Identical or equivalent elements will be denoted by the same reference signs in the description of the drawings, without redundant description.

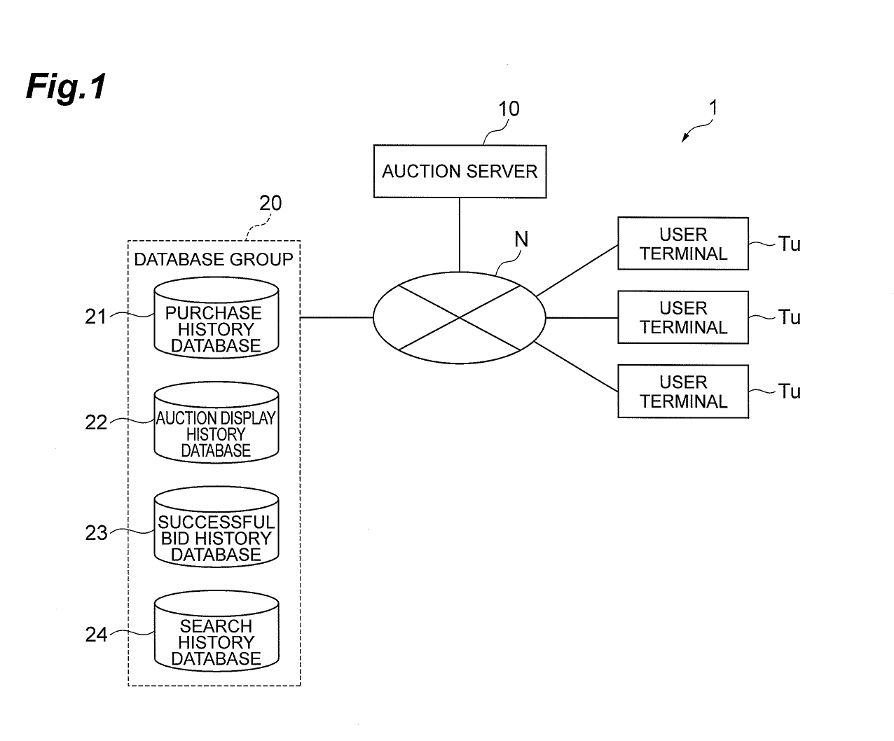

First, the function and configuration of the auction server 10 according to an embodiment will be described using FIGS. 1 to 11. The auction server 10 is a constituent element of an auction system 1. The auction system 1 is a computer system for providing a website of an Internet auction (auction site) to users (ordinary consumers). The users can display their possessions or bid for others' products under display for auction through the site. When a user makes a successful bid for a desired product, the user can acquire the product in exchange for payment to a seller. The auction system 1 is provided with a database group 20 and user terminals Tu, in addition to the auction server 10. These devices are connected to each other through a communication network N.

The auction server 10 is a computer system that manages the auction site. The auction server 10 executes provision of various web pages such as a main page and web pages classified by genres (or categories of products), searches for products under display for auction, auction processes (processes concerning display for auction, bidding, successful bids, payment, etc.), and so on in response to requests from the user terminals Tu. The auction server 10 has a function to present a user with an auction display candidate of a product which was purchased by the user in access to the auction site. There are no restrictions on types of products and rights of use of services (e.g., a right of use of facilities, a right of participation in a concert, etc.) are also sorts of products.

The database group 20 is an aggregate of various databases needed in the auction system 1. Installation places of the respective databases in the database group 20 are optional; for example, all the databases may be installed together at a certain place, or they may be installed at separate places.

The user terminals Tu are computers owned by the users. There are no restrictions on types of the user terminals Tu; for example, they may be desktop or portable personal computers or may be portable terminals such as highly-functional cell phones (smartphones), cell phones, and personal digital assistances (PDAs). There are no restrictions on the number of user terminals Tu existing in the auction system 1, either.

On the premise of the above setup, the details of the auction server 10 will be described below. First, the various databases accessed by the auction server 10 will be described in detail.

A purchase history database (purchase history memory) 21 is a means for storing purchase histories of the users. The purchase histories are records indicative of past purchases of products through the Internet by the users.

A website may be optionally determined as one purchase procedures at which are to be recorded and, in relation thereto, there are no restrictions on the installation place of the purchase history database 21, either. For example, the purchase history database 21 may store either or both of purchase histories of respective users at an online shopping site and purchase histories of respective users at the auction site (histories of acquisition of products by successful bids). Alternatively, the purchase history database 21 may store information under user's consent out of purchase histories stored in a payment system by electronic money or credit card. As another alternative, the purchase history database 21 may be a collection of purchase history databases stored in these various sites and systems.

When reference is made to a purchase history database without all product attributes like the payment system, a product database in the auction system or in the online shopping system may be searched using a product name or the like to specify product attributes (e.g., a genre). If two or more values are specified for one item of product attributes, one attribute value may be determined by the technique of majority rule. Alternatively, a plurality of product attributes that can lead to a product may be retained by associating the product with one or more attribute values to which products belong in the number of not less than a predetermined threshold.

For example, let us suppose that a product database is searched for product “boots” and there are 15,000 hits of boots belonging to genre “ladies' fashion,” 6,500 hits of boots belonging to genre “men's fashion,” and 1,000 hits of boots belonging to genre “kids and babies” extracted as a result. In this case, the genre of product “boots” may be set to “ladies' fashion” by the technique of majority rule, or, for example, with the threshold of 2000, both of “ladies' fashion” and “men's fashion” may be set as genres of the product.

When the technique of majority rule is applied, “ladies' fashion” with the largest number of hits is set for men's boots and as a result, a user browsing the genre of men's fashion at the auction site will not extract any of the boots. On the other hand, when both of “ladies' fashion” and “men's fashion” are set as genres against the men's boots as described above, a user browsing the genre of men's fashion at the auction site can extract any one of the boots. As described above, the technique of setting a plurality of genres for one product is effective when the genre determined by the technique of majority rule is different from the original genre.

If genres are different between sites or between systems, a database storing a correspondence table thereof may be used.

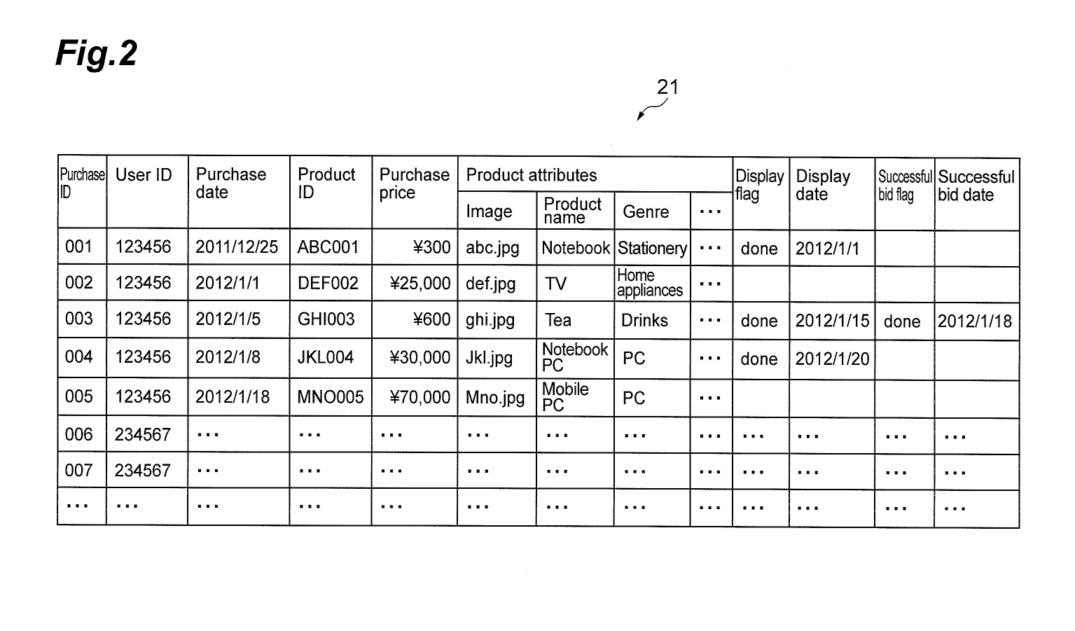

As shown in FIG. 2, each record of the purchase history includes a purchase ID, a user ID, a purchase date, a product ID, a purchase price, various attributes of a product (e.g., a link to a product image, a product name, a product genre, a description, etc.), a display flag, a display date, a successful bid flag, and a successful bid date. The display date and the successful bid date can include time.

The purchase ID is an identifier for specifying an individual purchase. The user ID is an identifier for specifying a user and the user ID applicable herein can be a member ID allocated to a member of the auction site or an e-mail address of the user. The user ID in the purchase history specifies a purchaser. The product ID is an identifier for specifying a product and the product ID to be set herein can be a common code among shops (e.g., a model number) or a unique ID determined by a shop. If the same product has different IDs among shops, whether products are identical may be checked using catalogue information of model numbers or the like.

The display flag is information indicative of whether a user has displayed a purchased product for auction at the auction site, and in FIG. 2 completion of display for auction is indicated by “done” and incompletion of display for auction by a blank. The successful bid flag is information indicative of whether a successful bid for a product displayed for auction by a user was made at the auction site, and in FIG. 2 completion of a successful bid is indicated by “done” and incompletion of a successful bid by a blank. The display flag, display date, successful bid flag, and successful bid date are suitably updated according to an auction display process or a successful bid process by the auction server 10. If no successful bid is made for a product, the display flag and the display date are cleared and in this case, these two items can be again set by re-display for auction.

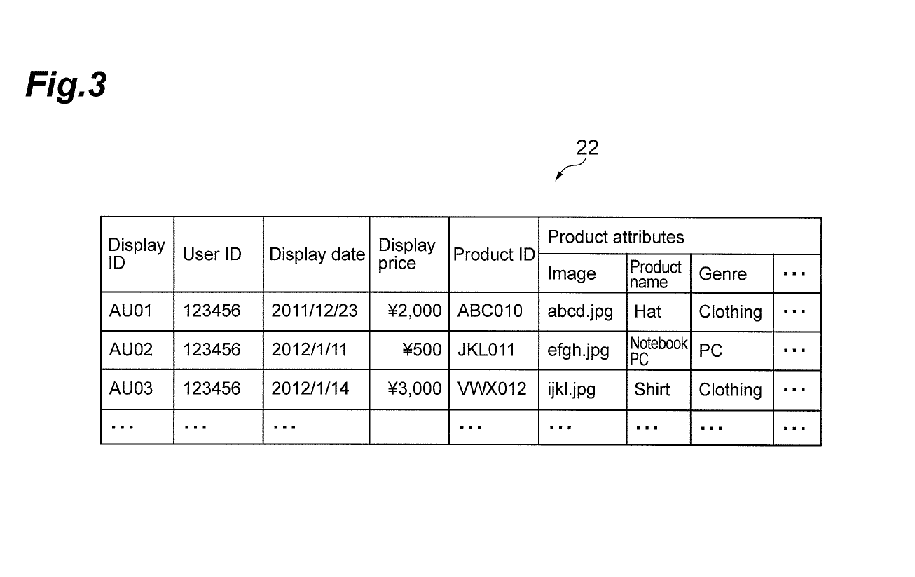

The auction display history database (auction display history memory) 22 is a means for storing histories of displays for auction at the auction site. As shown in FIG. 3, each record of the auction display history includes a display ID, a user ID of a seller, a display date, a display price (a current highest bid), a product ID, and product attributes (e.g., a link to a product image, a product name, a product genre, a description, and so on). The display ID is an identifier for specifying an individual display for auction. The display date can include time.

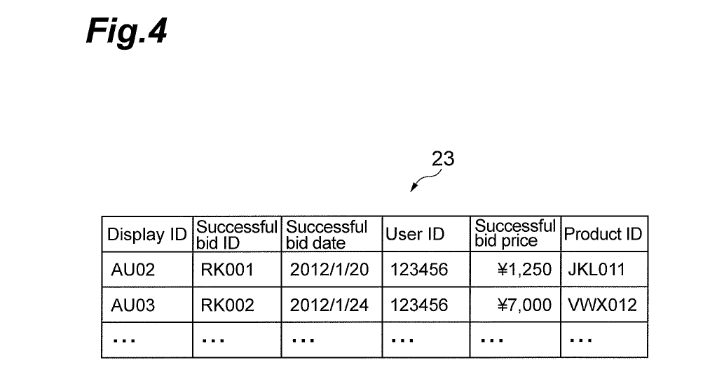

The successful bid history database (successful bid history memory) 23 is a means for storing histories of successful bids at the auction site. As shown in FIG. 4, each record of the successful bid history includes a display ID, a successful bid ID, a successful bid date, a user ID of a buyer, a successful bid price, and a product ID. The successful bid ID is an identifier for specifying an individual successful bid. The successful bid date can include time.

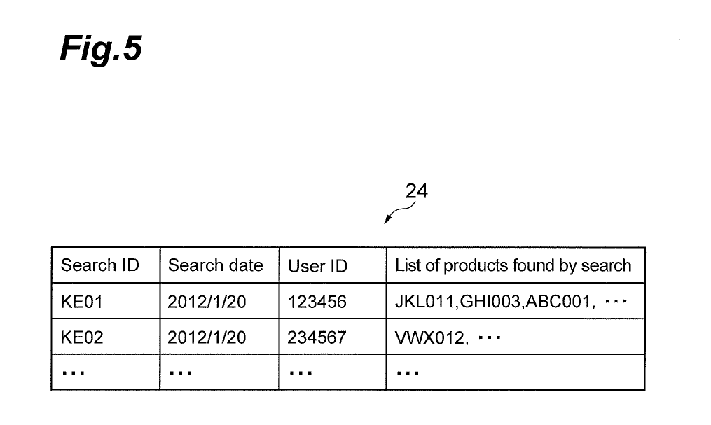

The search history database (search history memory) 24 is a means for storing histories of searches (search histories) by the users at the auction site. As shown in FIG. 5, each record of the search history includes a search ID, a search date, a user ID of a searcher, and a list of products found by a search. The search ID is an identifier for specifying an individual search process. The list of products is a collection of product IDs extracted in the search process. The search date can include time.

The configurations of the respective databases (or the respective records) do not have to be limited to those shown in FIGS. 2 to 5, and the databases may be subjected to any normality or redundancy.

The database group 20 can include other databases such as a user database storing user information (member information) and a product database storing product information. The user information is identified by user IDs and the product information by product IDs.

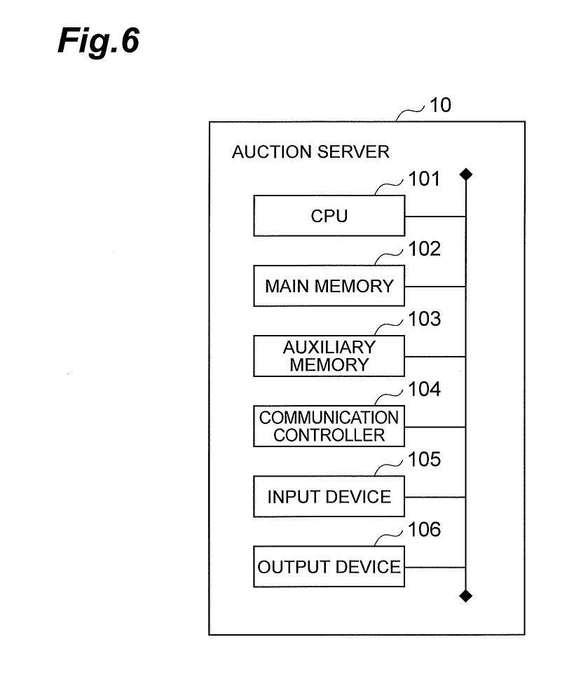

The below will describe the function and configuration of the auction server 10. FIG. 6 shows the hardware configuration of the auction server 10. As shown in this drawing, the auction server 10 is provided with a CPU 101 for executing an operating system, an application program, and so on, a main memory part 102 composed of a ROM and a RAM, an auxiliary memory part 103 composed of a hard disk or the like, a communication control unit 104 composed of a network card or the like, an input device 105 such as a keyboard and a mouse, and an output device 106 such as a display.

Each of below-described functional components of the auction server 10 is implemented by having predetermined software retrieved on the CPU 101 or the main memory part 102, operating the communication control unit 104, the input device 105, the output device 106, etc. under control of the CPU 101, and performing readout and writing of data from or into the main memory part 102 or the auxiliary memory part 103. Data and databases necessary for processing are stored in the main memory part 102 or in the auxiliary memory part 103. At least a part of the aforementioned database group 20 may be located in the auction server 10. FIG. 6 shows the configuration wherein the auction server 10 is composed of one computer, but the functions of the auction server 10 may be dispersed over a plurality of computers.

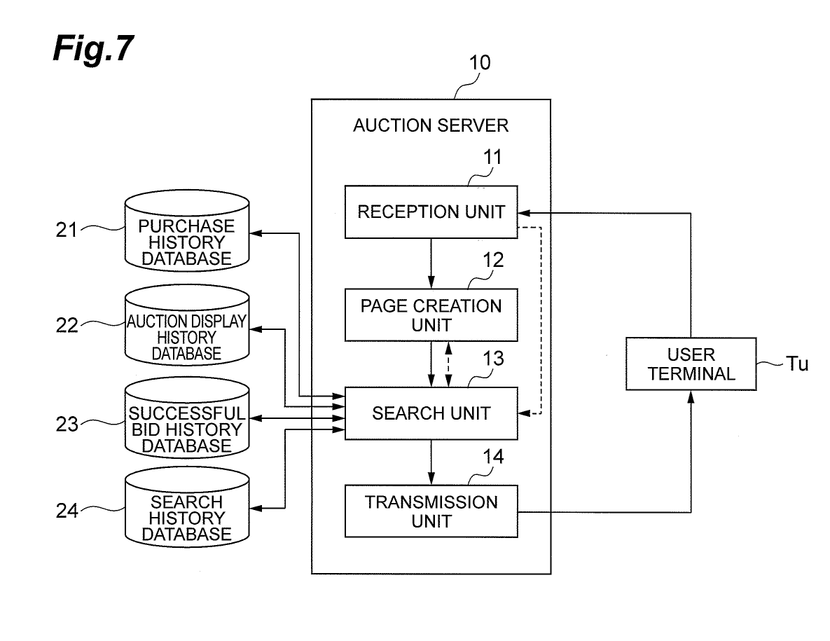

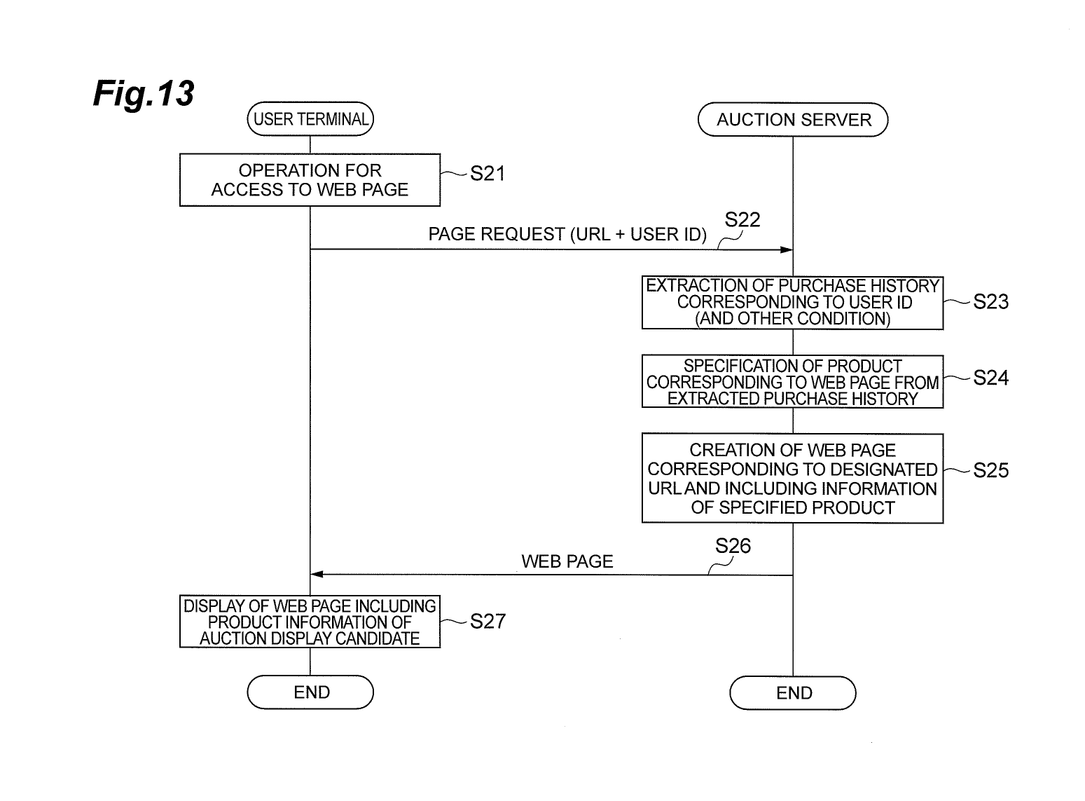

When a user accesses a web page of the auction site, the auction server 10 specifies a product corresponding to the web page from the purchase history of the user and presents information of the product along with the web page to the user. In order to execute such information presentation, the auction server 10 is provided with a reception unit 11, a page creation unit 12, a search unit 13, and a transmission unit 14 as functional components. These functional components are shown in FIG. 7. They will be described below along a flow indicated by solid arrows in FIG. 7. A flow indicated by dashed arrows in FIG. 7 corresponds to a modification (process shown in FIG. 13) in part of the foregoing flow.

The reception unit 11 is a means for receiving a page request for access to a web page of the auction site from a user terminal Tu. This page request is an HTTP request containing a user ID and a URL of the web page to be displayed on the user terminal Tu. The user ID may be managed by an HTTP cookie or may be entered at the user terminal Tu by the user. The reception unit 11 outputs this page request to the page creation unit 12.

The page creation unit 12 is a means for creating a web page demanded by a page request. When the URL in the page request indicates a top page of the auction site, the page creation unit 12 creates the top page. If the URL contains a parameter designating a specific genre, the page creation unit 12 creates a web page including a list of displayed products belonging to the genre designated by the parameter. If the URL contains a parameter indicating a search condition (query) for displayed products, the page creation unit 12 searches a database of displayed products (not shown) using the search condition and creates a web page showing a list of displayed products meeting the condition. As a matter of course, web pages created by the page creation unit 12 are not limited to these exemplified pages. The page creation unit 12 outputs data of the created web page along with the user ID to the search unit 13.

The search unit 13 is a means for specifying one or more products corresponding to a web page to be displayed, out of products having been purchased in the past by a user. A product specified by the search unit 13 is a product that can be a candidate for display for auction at the auction site and will also be referred to as “auction display candidate” in the present specification. The processing procedure of product specification by the search unit 13 is generally classified into two parts, extraction of the purchase history and refinement based on a content of the web page. The extraction of purchase history can be classified into two cases, a case using a record other than the purchase history and a case not using the other record. The search unit 13 can also set an order of displaying auction display candidates on the user terminal Tu.

[Extraction of Purchase History]

(Process not Using any Record Other than Purchase History)

The search unit 13 extracts at least a record of the purchase history in correspondence to a user ID of a page request from the purchase history database 21. A variety of methods as described below can be contemplated as specific extraction methods for the foregoing extracting process. The term “correspondence to a user ID” means coincidence between the input user ID and the user ID in the purchase history, or, substantial designation of an identical user by these IDs different from each other. In the latter case, a judgment on identity of user can be made by making use of cooperation between services by OAuth which is a framework about delegation of authorization information.

For example, the search unit 13 may extract a record with correspondence of the user ID and without the display flag “done.” Extracted in this case is a product which was purchased in the past by the user and which is not displayed for auction at least at present. Since the display flag of a sold product is kept “done,” the product after a successful bid is not extracted here. This condition of “a product which was purchased in the past by the user and which is not displayed for auction at least at present” may be used as a premise in the other extraction methods below.

In another method, the search unit 13 may extract a record indicative of a product with correspondence of the user ID and with a match to the present time (e.g., a season). There are no restrictions on how to determine whether a product matches the present time. For example, the search unit 13 may extract a record with a date indicated by the purchase date whose difference from the present date is within a predetermined range. In another case, the search unit 13 may select an extracted product by judging a sales time or season of the product on the basis of keywords in the product attributes (the name of the product, the description thereof, etc.) and comparing the judged time with the present time. Selected in this case is a product which is in demand in the present time (season) and which is expected to be highly likely sold.

In another method, the search unit 13 may extract a record with correspondence of the user ID and with a lapse from the purchase date (a difference between the purchase date and the present date) not less than a predetermined threshold. In this case, the search unit 13 extracts a product after a lapse of a predetermined time from a purchase thereof, but does not extract any product without a lapse of much time from a purchase thereof and with a relatively low possibility of display for auction. In this case, a product immediately after a purchase can be prevented from being erroneously displayed for auction.

The threshold may be designated by the user or may be determined by the search unit 13. In the latter case, the search unit 13 may set a threshold for each genre. For example, the search unit 13 may set the threshold for each genre by referring to the purchase history database 21 and the auction display history database 22 to calculate a statistical value (e.g., an average or a minimum) of durations from a purchase to a display for auction of products in each genre and defining the calculated duration as a threshold in each genre. Since durations of use of products differ depending upon types thereof, the setting of thresholds in respective genres of products allows the device to present auction display candidates at appropriate timing.

With a failure in specifying one-to-one correspondence between a purchase history and an auction display history, the search unit 13 may determine a duration from a purchase to a display for auction by making correspondence between an auction display history and a purchase history having a purchase date before a display date of the auction display history. The search unit 13 may calculate a threshold of duration for each user, may calculate a threshold for each user attribute such as sex or age (with reference to the user database to acquire the user attributes in this case), or may obtain a threshold common to all the users.

(Process Using Record Other than Purchase History)

As a modification of the method for selecting a product with a lapse of the predetermined time from its purchase, the search unit 13 may extract a purchase history in view of present auction display situations as well as the elapsed time from the purchase. Specifically, the search unit 13 extracts as a long held product a record with correspondence of the user ID and with a lapse of a period from a purchase date not less than the predetermined threshold, in the same manner as above. Then the search unit 13 extracts as a short held product a record with correspondence of the user ID and with a lapse of a period less than the threshold and makes a comparison for each short held product to determine which is higher between a user's purchase price and a successful bid price at the auction site.

The user's purchase price can be acquired from the purchase history. On the other hand, the successful bid price as a comparison object is a statistical value (e.g., an average or a maximum) of successful bid prices indicated by at least one successful bid history corresponding to an extracted product ID.

In calculating the statistical value, the search unit 13 multiplies a successful bid price of a product by a predetermined coefficient based on a quality acquired from the description of the displayed product (e.g., a keyword such as “damaged”) to adjust the successful bid price of each individual product. This means that the successful bid price as a basis of calculation of the statistical value is adjusted on the assumption that the quality of the product is at an initial level at a sales point of time. Alternatively, the search unit 13 may calculate two or more types of statistical values according to the quality of the product. For example, for a certain product ID, the statistical values are calculated respectively for successful bid histories of products with the description of “new” and for successful bid histories of products with the description of “used” and either one of the statistical values may be used by designation by the user or by the search unit 13.

The search unit 13 specifies a short held product whose statistical value of successful bid price is higher than its purchase price and the search unit 13 finally extracts the long held product and the short held product meeting the foregoing condition. When a successful bid is made for a product at a price higher than upon purchase as described above, the product is extracted irrespective of its purchase time, thereby motivating the user to display the product for auction.

In another method, the search unit 13 may extract a purchase history with correspondence of the user ID and with the statistical value of successful bid price (e.g., an average or a maximum) not less than a predetermined threshold. In this case, since a product expected to be sold over a certain level is extracted, the user is motivated to display the product for auction. The threshold may be designated by the user or may be preliminarily determined for each product by the search unit 13. Alternatively, the threshold may be a user's purchase price indicated by the purchase history. The search unit 13 extracts a purchase history corresponding to a user ID and calculates the statistical value of successful bid price based on the successful bid history, for each of product IDs indicated by the purchase history. Then the search unit 13 finally extracts only the purchase history with the statistical value not less than the threshold.

In another method, the search unit 13 may extract a product with correspondence of the user ID and with a demand for the product at the auction site being not less than a predetermined level.

Specifically, the search unit 13 first extracts the purchase history corresponding to the user ID from the purchase history database 21. Then the search unit 13 refers to the search history database 24, the auction display history database 22, and the successful bid history database 23 for each of product IDs indicated by the purchase history to obtain a search count and a supply index of each product in a predetermined duration, and calculates a demand index (=search count/supply index) indicative of the trend of demand. The supply index may be the number of auction displays or the number of products displayed for auction and sold in the predetermined duration. Next, the search unit 13 finally extracts only the purchase history with the demand index not less than a predetermined threshold.

The below will describe an example of calculation of the demand index. For example, let us assume that a search of the purchase histories for word α results in extracting three products A, B, and C and that at the auction site a search count of these three products with the word α is 100. Furthermore, the numbers of auction displays of the products A, B, and C are assumed to be 200, 300, and 400, respectively. In this case, the demand index of product A is 100/200, that of product B 100/300, and that of product C 100/400; therefore, it can be said that the demand becomes higher (more popular) in the named order of products A, B, and C.

Since seasonal products often experience variation in the trend of demand, depending upon seasons, the demand index for them may be determined in view of occasions of auction display and successful bid. For example, the search unit 13 may determine the demand index from the number of successful bids of products displayed for auction in a certain duration, in this duration, and the search count of the products in the same duration. Alternatively, the search unit 13 may determine the demand index from the number of auction displays or the number of successful bids of products in a certain duration, and the search count of the products in the same duration.

The products estimated to be in demand but in little supply are extracted by the techniques as described above. The threshold may be designated by the user or set by the search unit 13. The search unit 13 may obtain a change in the demand index in a plurality of consecutive durations for each product and finally extract the purchase history of a product the change in the demand index of which matches a predetermined pattern. In either case, by extracting products expected to be in demand over a certain level, the products expected to achieve a successful bid can be presented as auction display candidates to the users.

There are the various extraction methods of the purchase history as described above, and the search unit 13 may use two or more types of techniques to extract the purchase history.

[Refinement Based on Content of Web Page]

After extracting at least the purchase history corresponding to the user ID as described above, the search unit 13 specifies a product corresponding to a content of a web page from the purchase history. There are no restrictions on methods of specifying the product.

When the web page indicates a content about a certain specific genre, the search unit 13 specifies the purchase history with a product attribute coincident with the genre. When the web page indicates the search result based on a query transmitted from the user terminal Tu, the search unit 13 specifies the purchase history with a product attribute matching the query. When the web page is the top page of the auction site, the search unit 13 may select all the extracted purchase histories. The search unit 13 outputs the purchase history specified based on the content of the web page, along with data of the web page to the transmission unit 14.

By specifying the product corresponding to the content of the web page as described above, the auction display candidate can be presented in accordance with the product attribute under user's current interest. As a result, the convenience associated with display for auction is expected to improve.

If there is no product finally specified by the search unit 13, the search unit 13 may output all the purchase histories corresponding to the user ID to the transmission unit 14, in order to avoid indication of no auction display candidate.

[Setting of Display Order]

When outputting the specified purchase history to the transmission unit 14, the search unit 13 may set a display order of auction display candidates. For example, the search unit 13 obtains the aforementioned demand index for each product and rearranges the products in a decreasing or increasing order of values thereof. Alternatively, the search unit 13 may rearrange the products in a decreasing or increasing order of any one of statistical values of past successful bid prices, search counts, and purchase dates. The statistical values of successful bid prices of respective products are obtained by reference to the successful bid histories and totalization, and the search counts of respective products are obtained by reference to the search histories and totalization. By setting the display order of products as described above, the user can readily determine the necessity for display for auction.

The transmission unit 14 is a means for transmitting the product information of auction display candidate(s) specified by the search unit 13 and the web page created by the page creation unit 12, as a response to the page request to the user terminal Tu. The product information such as the product attributes and the purchase prices can be obtained from the purchase histories of the products specified by the search unit 13.

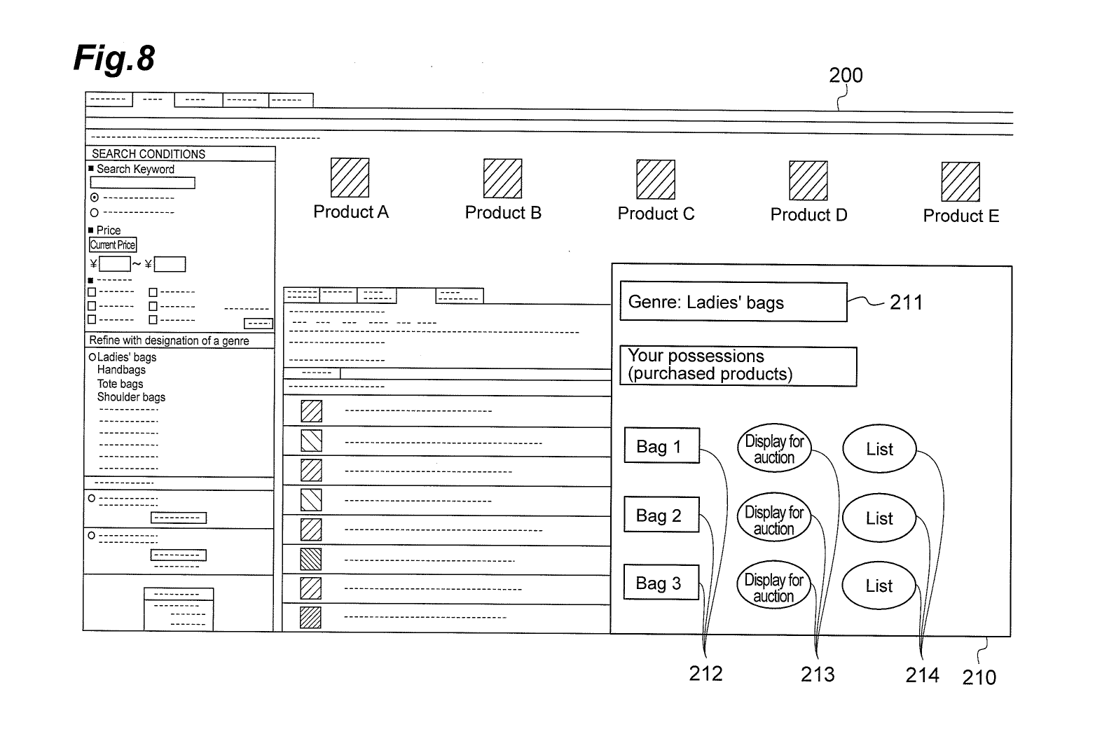

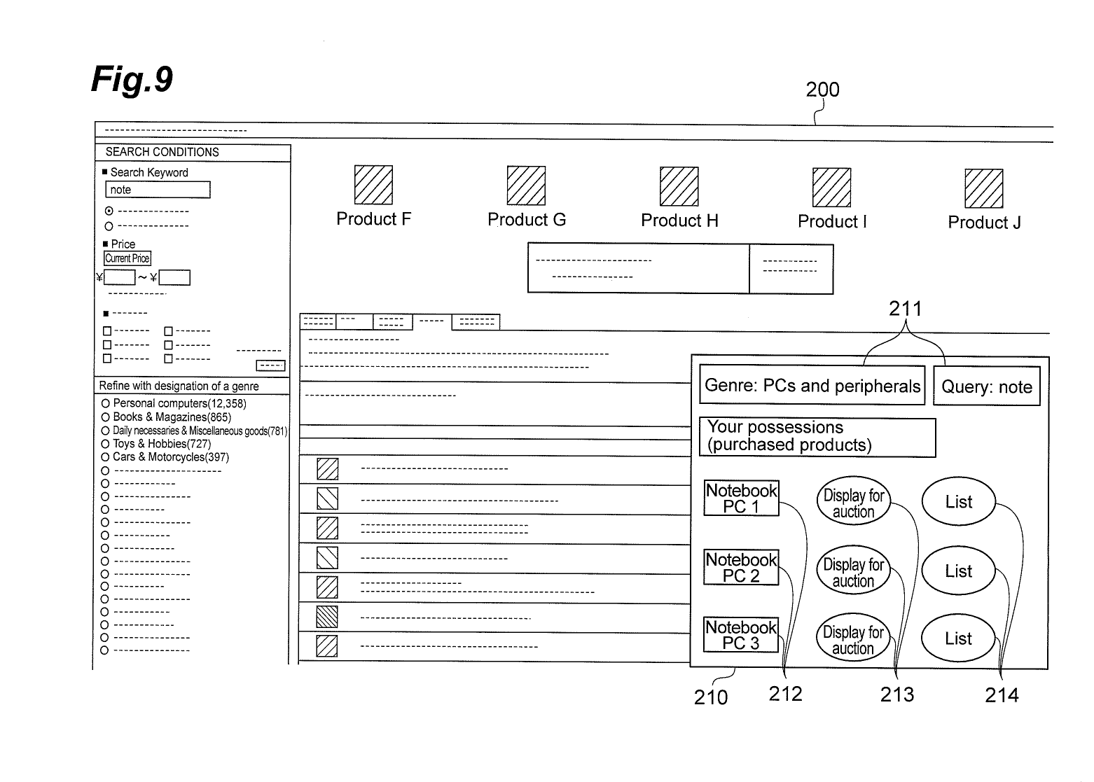

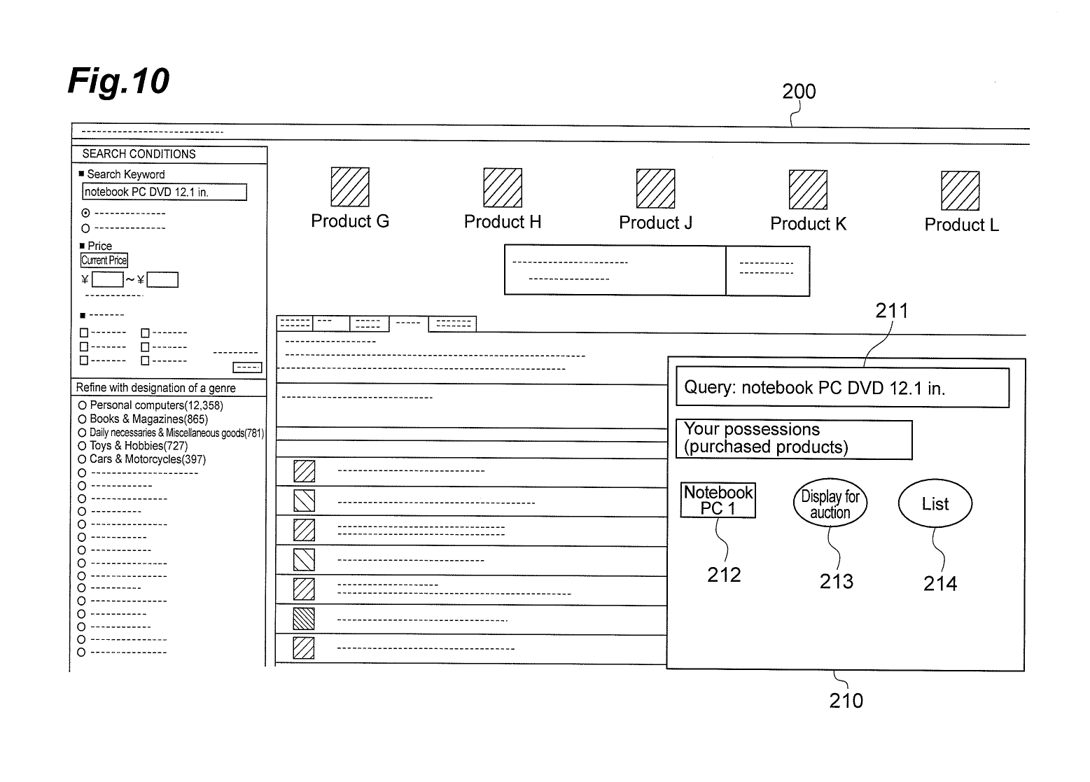

It is assumed in the present embodiment that the product information of auction display candidate(s) is displayed in a window (auction display window) different from the web page. FIGS. 8 to 10 show examples of displaying an auction display window on the user terminal Tu. FIG. 8 shows an example in which the auction display window 210 is displayed along with the web page 200 of a specific genre. FIG. 9 shows an example in which the auction display window 210 is displayed along with the web page 200 of a genre and the search result with a keyword. FIG. 10 shows an example in which the display window 210 is displayed along with the web page 200 of the search result with keywords only. The transmission unit 14 also transmits data for displaying this auction display window 210 to the user terminal Tu.

There are no restrictions on specific implementation methods of the auction display window 210. For example, the auction display widow 210 may be displayed on a Web Browser. In another method, the auction display window 210 may be displayed in a mode of a window independent of the web browser (e.g., a mode of a window realized by Javascript (trademark or registered trademark).

The auction display window 210 includes main page information 211 about the web page displayed based on the page request, a list of auction display candidates (candidate list) 212, auction display buttons (auction display interfaces) 213, and list buttons (list addition interfaces) 214. The main page information 211 is the genre displayed in FIG. 8, the query consisting of the genre and the keyword displayed in FIG. 9, and the query consisting of the keywords only displayed in FIG. 10. The auction display window 210 displays each product in a mode in which the user can display the product in the candidate list for auction at the auction site.

In FIG. 8, in accordance with user's designation of the genre of ladies' bags, a list of displayed products in the genre (such as Products A to E) are displayed on the web page 200 and bags 1, 2, and 3 having been purchased by the user are displayed as the candidate list 212. In FIG. 9, in accordance with user's designation of the genre “personal computers and peripherals” and keyword “note,” a list of displayed products matching the query (such as Products F to J) are displayed on the web page 200 and notebook PCs 1, 2, and 3 having been purchased by the user are displayed as the candidate list 212. In FIG. 10, in accordance with user's input of the three keywords “notebook PC DVD 12.1 inches,” a list of displayed products matching the query (Products G, H, J, K, and L) are displayed on the web page 200 and notebook PC 1 having been purchased by the user is displayed as the candidate list 212.

If a search is conducted with a keyword only, there will be a possibility of extraction of products not intended by the user. For example, when a search is conducted with a keyword of “note,” products in genres different from each other, “notebook PCs” and “notebooks,” can be extracted at the same time. Therefore, when the user intends to search for a notebook PC, “notebooks” not intended by the user are extracted. The situation in which the product not intended by the user is extracted can be avoided if the search is conducted with the query including the genre as well as the keyword.

What item should be displayed as the product information in the candidate list 212 may be optionally determined. For example, a product name, an image, and a purchase price may be displayed as the product information in the auction display window 210.

In an applicable method, information indicative of an acquisition source of the purchase history is preliminarily retained, for example, in the purchase history database 21 and then a mark indicating at which site the product was purchased is displayed as part of the product information. For example, a mark indicative of either acquisition from the purchase history database in the auction site or acquisition from the purchase history database in the online shopping site may be displayed in the auction display window 210. This allows the user to remember a route of acquisition of a possession or a quality of a product at time of purchase (either new or used) and to determine the necessity for display for auction, based on the remembered information. In the product list 212, the products are displayed in the order set by the search unit 13.

The auction display button 213 is a user interface for displaying an auction display candidate for auction at the auction site. When the auction display button 213 is clicked, the current page is switched over to a web page (auction display page) for displaying a product corresponding to the button for auction. Therefore, the user can readily access the auction display page. When the auction display button 213 is clicked, at least part of the product information retained in the auction display window 210 (e.g., a name of the product, an image thereof, an average of successful bid prices, etc.) is automatically set in a corresponding input cell in the auction display page. This eliminates at least a part of an input work and thus allows the user to readily perform an auction display work.

The list button 214 is a user interface for adding a product to a waiting list in order to later display the product for auction. When the list button 214 is clicked, a web page or another window of the waiting list is displayed and a product corresponding to the button is added to the waiting list. The user can access the waiting list through a link on the web page of the auction site and select the product from the waiting list to display the product for auction in the same manner as in the case of the auction display button 213 being clicked. This allows the user to display the product for auction at any later time and to readily perform the auction display work on that occasion.

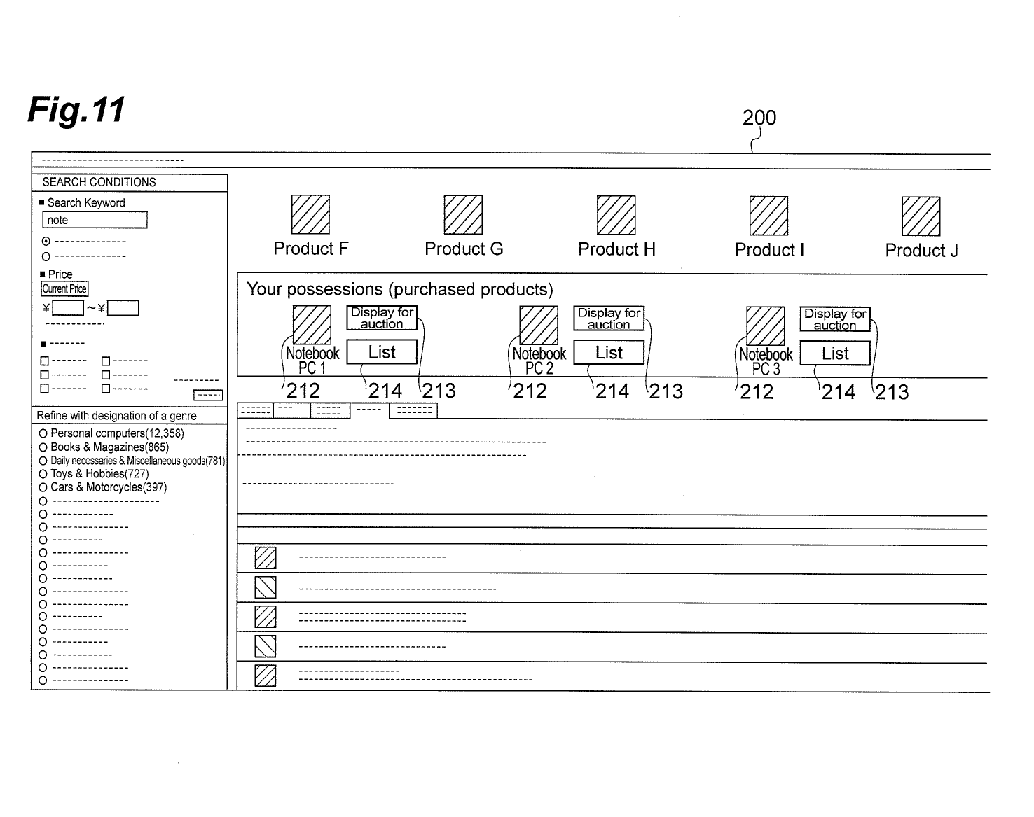

At least one of the auction display button 213 and the list button 214 may be omitted. The display methods of auction display candidates are not limited to the above examples and, for example, the product information of auction display candidates may be listed in the web page 200 as shown in FIG. 11. In the example of FIG. 11, the candidate list 212 (notebook PCs 1 to 3), together with the products under auction such as Products F to J, is displayed in the web page 200. As in FIGS. 8 to 10, the auction display button 213 and the list button 214 are prepared for each auction display candidate.

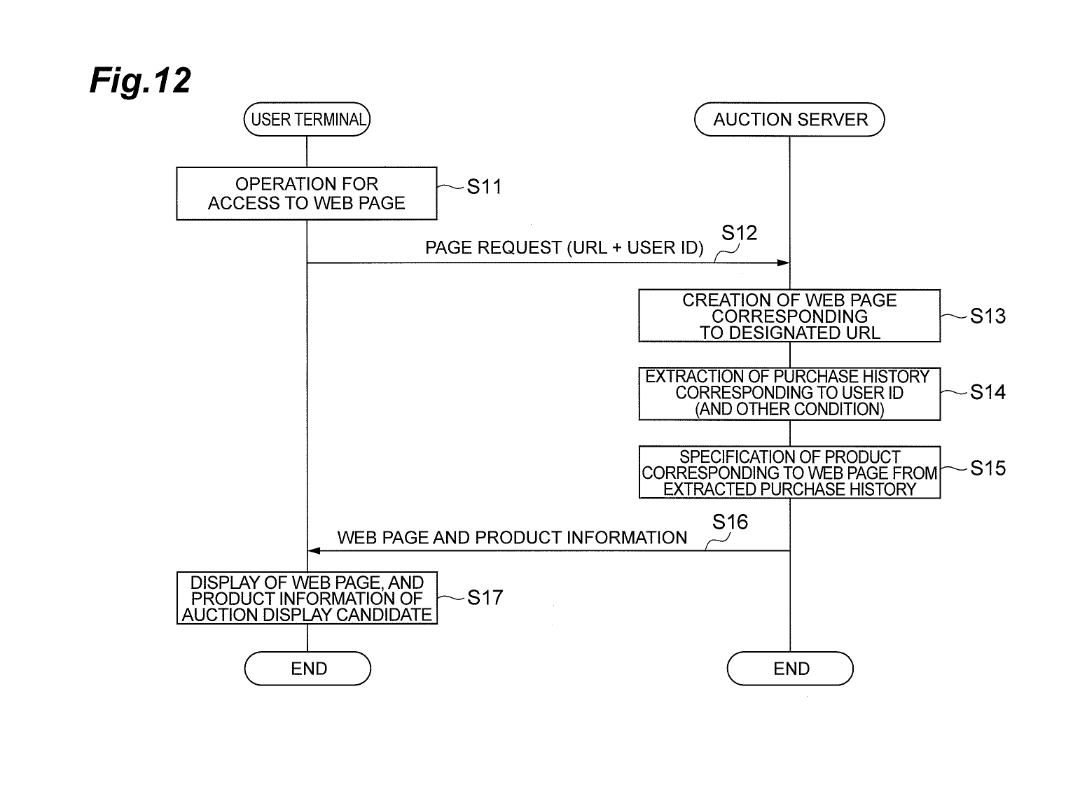

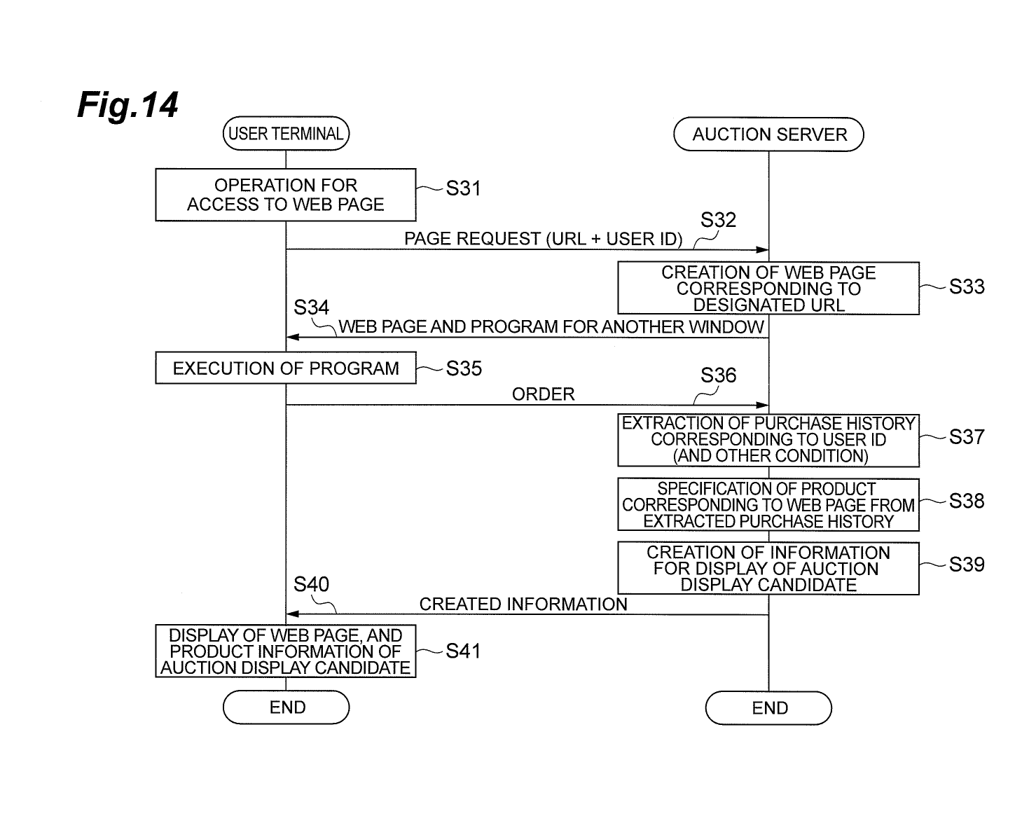

The below will describe the operation of the auction server 10 and the information providing method according to the present embodiment, using FIGS. 12 to 14. FIG. 12 shows an example of processing for displaying the auction display window separate from the web page on the user terminal Tu, and FIG. 13 an example of processing for providing the product information of auction display candidates as included in the web page, to the user terminal Tu. FIG. 14 shows a further modification of the processing procedure.

First, the processing will be described with reference to FIG. 12. When a user performs an operation for accessing the auction site (step S11), the user terminal Tu transmits a page request to the auction server 10 (step S12).

In the auction server 10 the reception unit 11 receives the page request (reception step). Next, the page creation unit 12 creates a web page indicated by a URL in the page request (step S13). Then the search unit 13 extracts the purchase history corresponding at least to the user ID in the page request, thereby to extract every product having been purchased in the past by the user (step S14, search step). The search unit 13 extracts every purchased product also meeting another condition in addition to the user ID, by the aforementioned various techniques. Then the search unit 13 specifies a product or products corresponding to the web page from the extracted purchase history (step S15, search step). The search unit 13 can also use the various techniques in this specifying process as described above. Then the transmission unit 14 transmits the created web page and the product information of auction display candidate(s) to the user terminal Tu (step S16, transmission step).

The user terminal Tu receives the web page and the product information and displays these on a screen (step S17). This allows the user to recognize each product having been purchased in the past by himself or herself, as an auction display candidate, and further allows the user to proceed with a procedure of displaying a product for auction from the auction display window or to add a product to the waiting list.

Next, the modification will be described with reference to FIG. 13. The processes of steps S21 and S22 are the same as the processes of steps S11 and S12 in FIG. 12.

In the auction server 10, when the reception unit 11 receives the page request (reception step), the search unit 13 extracts the purchase history corresponding at least to the user ID in the request to extract every product having been purchased in the past by the user (step S23, search step). Next, the search unit 14 specifies a product or products corresponding to the web page from the extracted purchase history (step S24, search step). The search unit 14 can acquire data of the web page indicated by the URL in the page request, from the page creation unit 12 to specify the product(s) corresponding to the page. Then the page creation unit 12 creates the web page indicated by the URL in the page request and showing the information of the product(s) specified by the search unit 14 (step S25). Then the transmission unit 14 transmits the web page including the product information of auction display candidate(s) to the user terminal Tu (step S26, transmission step).

The user terminal Tu receives the web page and displays it on a screen (step S27). In this case, the user can recognize the auction display candidate(s) on the web page and perform a procedure of displaying a product for auction or adding a product to the waiting list.

The below will describe the processing with reference to FIG. 14. The processes of steps S31 to S33 are the same as the processes of steps S11 to S13 in FIG. 12. Next, the transmission unit 14 transmits the created web page and a program for another window to the user terminal Tu (step S34). The program is realized, for example, by Javascript (trademark or registered trademark). When the user terminal Tu executes the program (step S35), the user terminal Tu transmits an order for extraction of auction display candidate(s) to the auction server 10 (step S36). The user ID may be transmitted to the auction server 10 in step S36, instead of in step S32.

The auction server 10 executes the same processes of steps S37, S38 as steps S14, S15 in FIG. 12, based on the order, and then creates information for displaying the auction display candidate(s) (step S39). The created information contains at least the product information and may further contain data for control of another window if needed. Finally, the transmission unit 14 transmits the created information to the user terminal Tu (step S40) and this causes the user terminal Tu to display the web page and the product information (step S41).

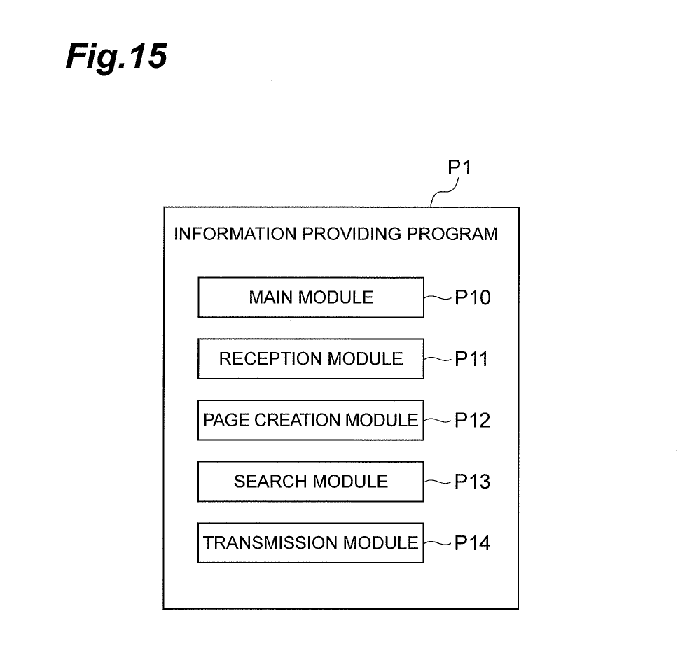

The below will describe an information providing program P1 for letting a computer function as the auction server 10, using FIG. 15.

The information providing program P1 is provided with a main module P10, a reception module P11, a page creation module P12, a search module P13, and a transmission module P14.

The main module P10 is a part that totally controls the information providing function. Functions implemented by execution of the reception module P11, page creation module P12, search module P13, and transmission module P14 are the same as the functions of the aforementioned reception unit 11, page creation unit 12, search unit 13, and transmission unit 14, respectively.

The information providing program P1 is provided, for example, in the form in which it is fixedly recorded on a material storage medium, e.g., a CD-ROM, a DVD-ROM, or a semiconductor memory. The information providing program may be provided in the form of a data signal superimposed on a carrier wave through the communication network.

According to the embodiments, as described above, when a user accesses a web page of the auction site, every product having been purchased by the user and corresponding to the content of the web page is specified. Then the specified product information is sent along with the web page to the user terminal Tu and the product information and the web page are displayed on the terminal Tu. For example, each product to be specified is one corresponding to the designated genre in the example of FIG. 8, one corresponding to the designated genre and keyword in the example of FIG. 9, and one corresponding to the designated keywords in the example of FIG. 10.

A user's attempt to access the auction site means that the user is interested in the auction. Therefore, by displaying information of a product as a candidate for display for auction at the time of the access, the user is notified of the possession of the auction display candidate at the time when the user is interested in the auction, and the user can be guided directly to the auction display operation. Since the product information of the auction display candidate corresponds to the web page of the auction site and is displayed along with the web page on the user terminal Tu, the user can readily determine whether the product is to be displayed. As a consequence of these, it is feasible to save more time and effort for the user to display the product for auction at the Internet auction.

To display the auction display candidate along with the web page upon the user's access to the auction site in order to allow the user to readily recognize the auction display candidate as in the embodiments is the technical effect that cannot be realized by the notification through e-mail as described in the aforementioned Patent Literature 1.

According to the embodiments, the user can compare the auctioned product displayed on the web page created by the page creation unit 12, with his or her possession as an auction display candidate and compare auction display candidates with each other.

The above described the present invention on the basis of the embodiments thereof. It is, however, noted that the present invention is not limited to the above embodiments. The present invention can be modified in various ways without departing from the spirit and scope of the invention.

The search unit 13 determined the display order of the product information in the auction display window in the above embodiment, but the auction display window may be created so as to allow the user to change the display order. Alternatively, a framework to be adopted may be one wherein the user sets the display order in the auction display window, instead of the method for the search unit 13 to determine the display order.

The function of creating the web page and the function of specifying the auction display candidate may be spread into respective servers different from each other. For example, the page creation unit is provided as a server different from the auction server 10 and the search unit 13 may receive the data of the web page from the server to specify the auction display candidate in the same manner as in the above embodiment.

### REFERENCE SIGNS LIST

1 . . . auction system; 10 . . . auction server; 11 . . . reception unit; 12 . . . page creation unit; 13 . . . search unit; 14 . . . transmission unit; 20 . . . database group; 21 . . . purchase history database (purchase history memory); 22 . . . auction display history database (auction display history memory); 23 . . . successful bid database (successful bid memory); 24 . . . search history database (search history memory); P1 . . . information providing program; P10 . . . main module; P11 . . . reception module; P12 . . . page creation module; P13 . . . search module; P14 . . . transmission module; Tu . . . user terminal.

1. An information providing device comprising:
a reception unit which receives a page request for access to a web page of an auction site from a user terminal, said page request containing an identifier for specifying a user;
a search unit which extracts a purchase history corresponding to the identifier from a purchase history memory storing purchase histories of products and which specifies a product having been purchased by the user and corresponding to a content of the web page; and
a transmission unit which transmits product information and the web page to the user terminal in order to display the product information of the product specified by the search unit, along with the web page on the user terminal in a state in which the user can display the product for auction at the auction site.

2. The information providing device according to claim 1,
wherein the transmission unit transmits an auction display interface for display for auction at the auction site of the product specified by the search unit, the product information, and the web page to the user terminal, and
wherein the auction display interface and the product information are displayed on the user terminal.

3. The information providing device according to claim 2,
wherein, when the user selects the auction display interface, the product information of the product specified by the search unit is set in an input cell in an auction display page of the auction site.

4. The information providing device according to claim 1,
wherein the transmission unit transmits to the user terminal, a list addition interface for adding the product specified by the search unit, to a waiting list for later displaying the product for auction, the product information, and the web page, and
wherein the list addition interface and the product information are displayed on the user terminal.

5. The information providing device according to claim 1,
wherein the search unit extracts the purchase history of a product for which a predetermined duration has elapsed since purchased by the user.

6. The information providing device according to claim 5,
wherein the search unit refers to a successful bid history memory storing successful bid histories at the auction site to extract the purchase history of a product for which the predetermined duration does not have elapsed since purchased by the user and whose successful bid price indicated by the successful bid history is higher than a purchase price indicated by the purchase history.

7. The information providing device according to claim 5,
wherein the predetermined duration is set for each product genre.

8. The information providing device according to claim 1,
wherein the search unit refers to a successful bid history memory storing successful bid histories at the auction site to extract the purchase history of a product whose successful bid price indicated by the successful bid history is higher than a purchase price indicated by the purchase history.

9. The information providing device according to claim 1,
wherein the search unit extracts the purchase history of a product corresponding to the present time, based on a product attribute or based on a purchase time of a product indicated by an arbitrary purchase history in the purchase history memory.

10. The information providing device according to claim 1,
wherein the search unit refers to an auction display history memory storing auction display histories at the auction site and a successful bid memory storing successful bid histories at the auction site to extract the purchase history of a product which was purchased by the user, which is not displayed for auction at present, and which was not sold in the past.

11. The information providing device according to claim 1,
wherein the search unit refers to a successful bid history memory storing successful bid histories at the auction site to extract the purchase history of a product whose successful bid price at the auction site is not less than a predetermined threshold, out of products indicated by the purchase history of the user.

12. The information providing device according to claim 1,
wherein the search unit refers to a search history memory storing search histories at the auction site and an auction display history memory storing auction display histories at the site to determine a demand index based on a search count and an auction display count for each of products indicated by the purchase history of the user and extract the purchase history of a product the demand index of which is not less than a predetermined threshold.

13. The information providing device according to claim 1,
wherein the web page is a page showing a result of a search based on a query contained in the page request, and
wherein the search unit specifies a product matching the query.

14. The information providing device according to claim 13,
wherein the query contains at least one of a keyword and a predetermined product genre.

15. The information providing device according to claim 14,
wherein the query contains both of the keyword and the product genre.

16. The information providing device according to claim 1,
wherein the purchase history memory stores at least one of purchase histories indicative of purchases at an online shopping site, purchase histories indicative of purchases at the auction site, and purchase histories indicative of purchases settled by payment through a payment system.

17. The information providing device according to claim 16,
wherein the purchase history memory stores the purchase histories indicative of the purchases at the online shopping site and the purchase histories indicative of the purchases at the auction site, and
wherein the product information of the product specified by the search unit contains information indicative of at which site the product was purchased between the online shopping site and the action site.

18. The information providing device according to claim 1,
wherein the search unit refers to at least one of a search history memory storing search histories at the auction site, an auction display history memory storing auction display histories at the site, and a successful bid history memory storing successful bid histories at the site to set a display order of the product information on the user terminal, and
wherein the display order is set based on at least one of a demand index based on a search count and an auction display count, a successful bid price, the search count, and a purchase time.

19. An information providing method to be executed by an information providing device, the information providing method comprising:
a reception step of receiving a page request for access to a web page of an auction site from a user terminal, said page request containing an identifier for specifying a user;
a search step of extracting a purchase history corresponding to the identifier from a purchase history memory storing purchase histories of products, and specifying a product having been purchased by the user and corresponding to a content of the web page; and
a transmission step of transmitting product information and the web page to the user terminal in order to display the product information of the product specified by the search step, along with the web page on the user terminal in a state in which the user can display the product for auction at the auction site.

20. (canceled)

21. A non-transitory computer-readable storage medium storing an information providing program for letting a computer execute:
a reception unit which receives a page request for access to a web page of an auction site from a user terminal, said page request containing an identifier for specifying a user;
a search unit which extracts a purchase history corresponding to the identifier from a purchase history memory storing purchase histories of products and which specifies a product having been purchased by the user and corresponding to a content of the web page; and
a transmission unit which transmits product information and the web page to the user terminal in order to display the product information of the product specified by the search unit, along with the web page on the user terminal in a state in which the user can display the product for auction at the auction site.
